(19) United States
(12) Patent Application Publication
(10) Pub. No.: US 2014/0201120 A1
(43) Pub. Date: Jul. 17, 2014

(54) GENERATING NOTIFICATIONS BASED ON USER BEHAVIOR

(71) Applicant: APPLE INC., Cupertino, CA (US)

(72) Inventors: Gregory T. Lydon, Cupertino, CA (US); Sylvain René Yves Louboutin, Sunnyvale, CA (US)

(73) Assignee: APPLE INC., Cupertino, CA (US)

(21) Appl. No.: 13/743,989

(22) Filed: Jan. 17, 2013

(51) Int. Cl. G06N 5/02

(52) U.S. Cl. CPC G06N 5/02
USPC 706/46

(57) ABSTRACT

In some implementations, a method for determining behavior associated with a user device includes receiving behavior data of the user device that includes multiple types of behavior data. The behavior data is compared with patterns of behavior data associated with the user device. The behavior-data patterns are generated from previously-received behavior data. A notification is generated based on comparing the behavior data to the behavior-data patterns.

### TECHNICAL FIELD

This disclosure relates to generating notifications based on user behavior.

### BACKGROUND

A user device can include multiple sensors that are configured to detect conditions and activities associated with a user. For example, the sensors may determine movement, rotation, ambient temperature, ambient light, magnetic fields, acceleration, and proximity. In addition to sensor data, the user device may be able to determine location, interactions with external devices, and user interactions with the user device. In short, a mobile device is a very personal item that typically accompanies their user more closely than other technology. In other words, no other device is more intimately associated with such a wide variety of an individual routines and day-to-day tasks than a user device such as a smart phone (e.g., iPhone®) or other similar devices (e.g., iPod Touch®). A mobile device is typically a location-aware, sensors-rich, powerful computing and highly customizable device that is in the physical possession of its user and is involved in a very wide range of personal activities such as a communication device, a navigation aid, a personal assistant, or a source of entertainment and information.

### SUMMARY

In some implementations, a method for determining behavior associated with a user device includes receiving behavior data of the user device that includes multiple types of behavior data. The behavior data is compared with patterns of behavior data associated with the user device. The behavior-data patterns are generated from previously-received behavior data. A notification is generated based on comparing the behavior data to the behavior-data patterns.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is an example behavior classification system.

FIG. 2 illustrates an example system for evaluating behavior data against clustered data.

FIG. 3 is a two-dimensional graph illustrating clustering of behavior data.

FIG. 4 is a flow chart illustrating an example method for comparing behavior data to behavior patterns.

FIG. 5 is a block diagram of exemplary architecture of a mobile device employing the processes of FIG. 4 in accordance with some implementations.

### DETAILED DESCRIPTION

### Exemplary Operating Environment

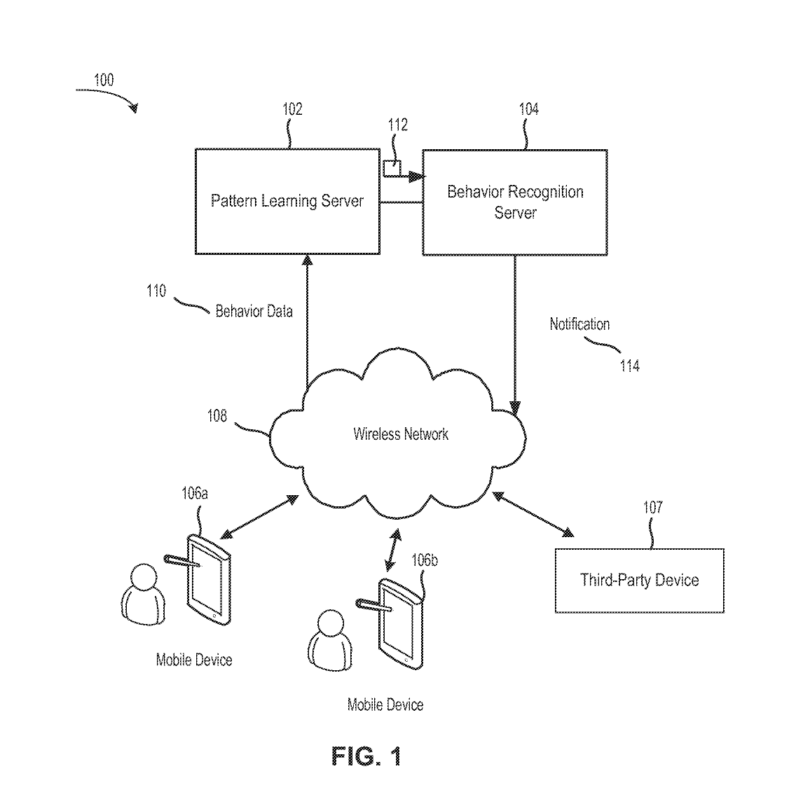

FIG. 1 is an example behavior classification system 100 that provides an overview of pattern learning and behavior recognition for behavior data. For example, the system 100 may determine behavior patterns of a mobile device over time based on historical behavior data and compare current behavior data to the behavior patterns to determine unusual activities associated with the mobile device. Behavior data typically includes data associated with activity of the user or the mobile device. For example, behavior data may include a time, a date, data from multiple sensors (e.g., motion sensor, magnetometer, light sensor, noise sensor, proximity sensor), location data, user interaction with the mobile device (e.g., application usage, gestures, buttons used, online activity), interaction with external devices (e.g., interaction with other users, connections to networks), as well as other additional behaviors (e.g., spelling errors, grammar, vocabulary, punctuation, case, keyboard orientation). By comparing the current behavior data to behavior patterns, the system 100 may protect against misappropriation or theft of the user device as well as unanticipated incidents or atypical events.

In some implementations, the behavior classification system 100 is a system including one or more computers programmed to generate one or more behavior patterns from historical behavior data and determine unusual behavior by comparing current behavior data to the behavior patterns. As illustrated, the behavior classification system 100 includes a pattern learning server 102 for determining behavior patterns based on historical data, a behavior recognition server 104 for determining unusual behavior using the behavior patterns, mobile devices 106a and 106b, and a third-party device 107 coupled through network 108. The mobile devices 106a and 106b may transmit behavior data 110 to the pattern learning sever 102 as training data for determining behavior patterns. In some implementations, the behavior data 110 can include a time series of behavior data including at least one of sensor data, location data, usage data, connection data, or other behavior data.

The pattern learning server 102 can include any software, hardware, firmware, or combination thereof configured to process the behavior data 110 and generate one or more behavior patterns 112. As previously mentioned, the behavior patterns 112 may include any combination of sensor patterns, location patterns, user-interaction patterns, communication patterns, or other behavior patterns. For example, sensor patterns may identify typical physical activity during the day such as patterns of sleep and inactivity, typical walk, gait or exercise, patterns of indoor or outdoor activity using, for example, light levels, noise levels, and temperatures, as well as other patterns. Alternatively to or in combination with the sensor patterns, the behavior patterns 112 may be based on one or more of the following: user interaction with the user interface of the mobile device 106a, 106b (e.g., most commonly used gestures, buttons pressed); locations such as when and where the user typically or routinely spends time; usage of applications or online activity (e.g., recreational breaks inferred from game or media player user, online services accessed); interactions with other users (e.g., phone calls, emails, messages); connections with familiar networks (e.g., Wifi); connections with external devices or accessories; spelling error rates (e.g., autocorrect rates); grammar; vocabulary; punctuation; case; keyboard orientation; typing tempo; or other behaviors.

In regard to grammar or vocabulary, the behavior pattern 112 may include a set of words or abbreviations associated with the user when composing texts, emails, and other documents. In regard to punctuation, the behavior pattern 112 may include phrases, words, and sentences associated with the user (e.g., parentheses rates, question mark usage as compared with bold statements, absence or presence of certain greetings or salutations such as “Hi” or “Cheers”). In some implementations, the behavior pattern 112 may include other punctuation patterns such as upper case or lower case text typically used by the user. The behaviors described above are for illustration purposes only, and the behavior patterns 112 may include all, some, or none of the behaviors without departing from the scope of the disclosure.

Due to the potentially intrusive nature of determining behavior patterns 112, the pattern learning server 102 may request that the user explicitly authorize the pattern analysis or filter out specific types of behavior that are analyzed. For example, the pattern learning server 102 may not record specific locations of the user over time but just a pattern of movements. In these instances, the pattern learning server 102 may only record relative locations of each point against other points to determine relative movement without having to storing specific locations associated with the movements. Furthermore, the pattern learning server 102 may not record the correct orientation of relative movements to further protect a user's privacy. In regard to patterns of communication with other users through phone calls, emails, and messaging, the pattern learning server 102 may not record with whom a user specifically communicates but just the pattern of communicating with entities that can be distinguished from one another. For example, the pattern learning server 102 may determine that the user regularly communicates around lunch time with entity A via messaging and less frequently in the evening with entity B on the phone. In these instances, the pattern learning server 102 does not record that A is John Doe and B is Jane Doe but just that A and B are two distinct contacts. The pattern learning server 102 may filter out similar data in other types of behavior to preserve the privacy of the user.

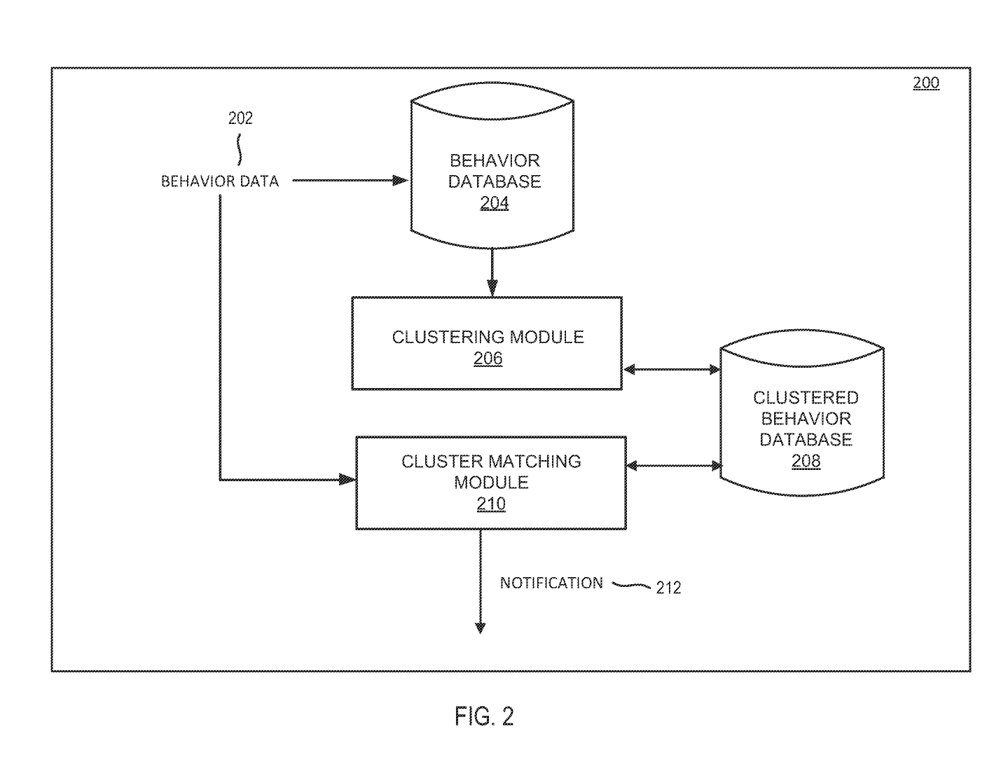

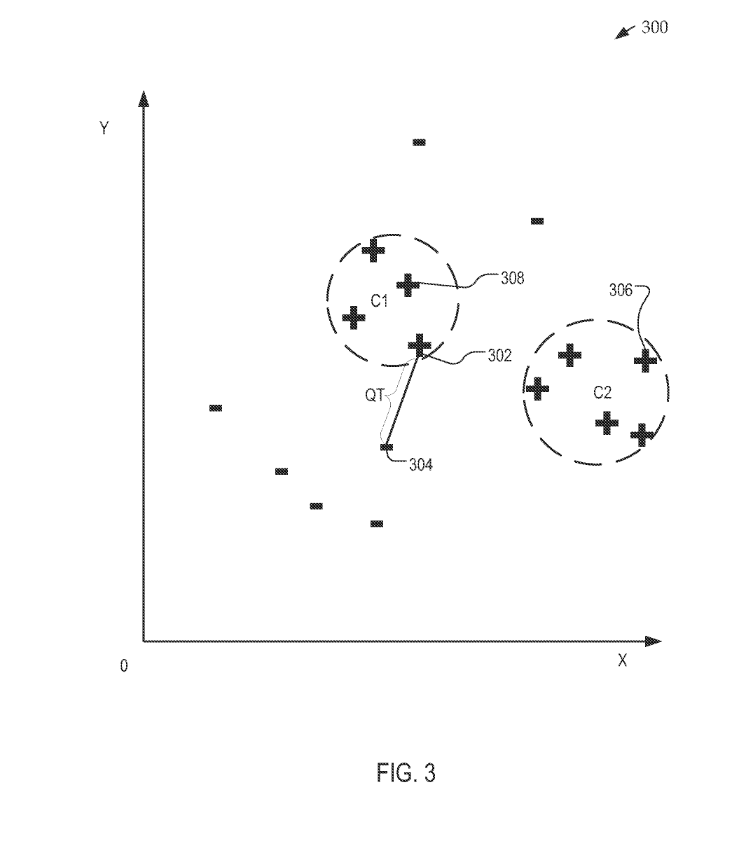

While determining patterns, the pattern learning server 102 may include representative data for each of the behavior patterns 112. For example, the behavior patterns 112 may include representative data for multiple sensors, associated thresholds for each type of sensor data, and a representative time period and an associated time threshold. The sensor-data thresholds in combination with the representative data may define an acceptable range for the behavior data 110 for multiple sensors, and the time threshold in combination with the representative time may define a time of day associated with the behavior. In some implementations, the correlation between the information from the various sensors may be sufficient to identify a behavior pattern 112. For example, being in a particular location while running may be usual while running in an otherwise place with low ambient noise may unusual. The combination of data provided by multiple sensors considered as a whole may reveal more than examining the sensor data individually. Similar to the sensor example, the behavior patterns 112 may include representative behavior data and associate behavior-data thresholds for each type of behavior data in the pattern 112. In some implementations, the representative behavior data may be determined based on averaging, a centroid of a cluster, or other pattern recognition algorithms. In addition, the behavior-data thresholds may be static such as a percentage of the representative behavior data or dynamic based on a size of a cluster of behavior data as discussed below in more detail with regard to FIGS. 2 and 3. As indicated above, each behavior pattern 112 may include timestamps or a time range to identify a time of a day associated with the behavior. In short, each behavior pattern 112 may serve as a model to which behavior data is compared such that unusual behavior can be recognized. The pattern learning server 102 can send behavior patterns 112 to behavior recognition server 104 for recognition of unusual behavior associated with the mobile device 106a, 106b.

Even though the behavior recognition server 104 is illustrated as separate from the pattern learning server 102 and the mobile device 106a, 106b, the pattern learning server 102 or the mobile device 106a, 106b may include the functionality of the behavior recognition server 104 without departing from the scope of the disclosure. In addition, the mobile device 106a, 106b may include the functionality of both the pattern learning server 102 and the behavior recognition server 104 without departing from the scope of the disclosure. Regardless, the behavior recognition server 104 can include any software, hardware, firmware, or combination thereof configured to identify unusual behavior associated with the mobile device 106a, 106b based on comparing the behavior data 110 to the behavior patterns 112. For example, the behavior recognition server 104 may determine whether the behavior data 110 satisfies the representative behavior data and the associated behavior-data thresholds defined by the behavior patterns 112. In other words, the behavior recognition server 104 may compare current behavior data 110 to each of the behavior patterns 112 to determine whether the behavior data 110 falls within any of the ranges defined by the representative behavior data and the associated behavior-data thresholds. In response to the behavior data 110 not matching any of the behavior patterns 112 or otherwise violating the behavior patterns 112, the behavior recognition server 104 may transmit a notification 114 identifying or otherwise indicating unusual behavior associated with the mobile device 106a, 106b. For example, the behavior recognition server 104 may transmit the notification to at least one of the mobile device 106a, 106b or the third-party device 107. The third-party device 107 may be managed by a relative, an associate, a health care provider, or other third party concerned with the user of the mobile device 106a, 106b. For example, the notification 114 may alert a health care provider that an elderly person may have fallen and is unable to call for help. In some implementations, the behavior recognition server 104 may transmit, through the network 108, a command to lock the mobile device 106a, 106b until the user is verified. For example, the notification 114 may include a command to lock the mobile device 106a, 106b until credentials (e.g., password) are received through the mobile device 106a, 106b and verified. To avoid false-positives, the behavior recognition server 104 may allow the user to quiet the alarm or teach new behavior to the device 106a, 106b by entering a password or other credentials.

### Example Behavior Classification System Using Clustering

FIG. 2 illustrates a behavior classification system 200 for using cluster evaluation of behavior data. For example, the system 200 may determine and store representative behavior data (B₁, B₂, B₃, . . . , Bₙ) and associated behavior thresholds (T₁, T₂, T₃, . . . , Tₙ). As illustrated, the system 100 includes behavior data 202, a behavior database 204 for storing historical behavior data, a clustering module 206 for determining clusters of the historical behavior data stored in the behavior database 204, clustered behavior database 208 for storing clustered behavior data, and a cluster matching module 210 for determining whether the behavior data 202 matches any clusters in the clustered behavior database 208.

In particular, the behavior data 202 may be received from mobile device 106a, 106b as described with respect to FIG. 1 and includes different magnitudes of different types of behavior data (A₁, A₂, A₃, . . . , Aₙ). For example, the behavior data (A₁, A₂, A₃, . . . , Aₙ) may include a time, a date, three data points for a three-axis magnetometer, a single data point for ambient noise, a single data point for ambient light, as well as other data points for behaviors.

The behavior data 202 may be passed to the behavior database 204 for storing historical behavior data and cluster matching module 210 for determining unusual behavior associated with a mobile device. In particular, the behavior database 204 stores magnitudes of the behavior data (A₁, A₂, A₃, . . . , Aₙ).

As previously mentioned, the stored behavior data (A₁, A₂, A₃, . . . , Aₙ) may include magnitudes of different types of behavior data. In addition, the stored behavior data (A₁, A₂, A₃, . . . , Aₙ) may include other parameters such as, for example, a time for the other behavior data. The time periods may be used to manage entries in the behavior database 204 or used to determine a time of day associated with the behaviors of the user or mobile device. For example, the times may be used to correlate different behavior data (A₁, A₂, A₃, . . . , Aₙ) that occur at the same time periods during the day.

In response to a trigger event, the clustering module 206 can include any software, hardware, firmware, or combination thereof configured to execute a clustering algorithm on behavior data (A₁, A₂, A₃, . . . , Aₙ) stored in the behavior database 204 to form clusters. For example, the clustering module 206 may apply the well-known clustering algorithm known as quality threshold clustering algorithm to entries in the behavior database 204 to create clusters of behavior data including representative data (B₁, B₂, B₃, . . . , Bₙ) and associated thresholds (T₁, T₂, T₃, . . . , Tₙ). A trigger event can be any event that triggers a clustering procedure in the behavior classification system 200. The trigger event can be based on time, location, mobile device activity, an application request, received behavior data, expiration of a time period, or other events. Other clustering algorithm may be used such as connectivity based clustering, centroid-based clustering, distribution-based clustering, density-based clustering, or others. In general, cluster analysis or clustering assigns a set of objects into groups, i.e., clusters, so that the objects in the same cluster are more similar to each other based on one or more metrics than to objects in other clusters. Further details of operations of clustering module 206 are described below in reference to FIG. 3.

The clustering module 206 stores the determined clusters in the clustered behavior database 208. For each cluster, the clustering module 206 may determine representative data (B₁, B₂, B₃, . . . , Bₙ) for each type of behavior data and an associated threshold (T₁, T₂, T₃, . . . , Tₙ). For example, the clustering module 206 may determine a mean magnitude Bₘ of each type of behavior data in the cluster as follows:

$${B}_{m} = \frac{{\sum }_{i = 1}^{N} {A}_{i}}{N} \qquad [ 1 ]$$

where N is the number of behavior datum in a specific type of behavior data in the cluster. For example, the cluster may include a mean of sensor data for each sensor type, a mean time, or a mean of other types of behavior data. The clustering module 206 may use other algorithms for determining representative behavior data (B₁, B₂, B₃, . . . , Bₙ) for each cluster without departing from the scope of this disclosure. In addition, the clustering module 206 may determine a magnitude threshold (T₁, T₂, T₃, . . . , Tₙ) for each type of behavior data. In some implementations, the magnitude threshold for each type of behavior data may be based on the standard deviation of the magnitudes for each type of behavior data in the cluster.

The cluster matching module 210 can include any software, hardware, firmware, or combination thereof for determining, for each of the clusters in the clustered behavior database 208, whether the behavior data 202 satisfies the mean magnitude and magnitude threshold for each type of behavior data in the cluster. In particular, the cluster matching module 210 may determine whether the estimated magnitude for each type of behavior data in a cluster is within the range of the mean magnitude for the behavior-data type plus the threshold for the behavior-data type in the cluster. The cluster matching module 210 iteratively executes these calculations to determine if the behavior data matches any of the clusters in the clustered behavior database 208. If the behavior data 202 does not match any clusters, the cluster matching module 210 issues a notification 212 of unusual behavior.

### Clustering Overview

FIG. 3 is a graph 300 illustrating exemplary clustering techniques of behavior data. In particular, the graph 300 is a two-dimensional space based on the behavior data (Aₓ, A_{y}). The clustering module 206 (as described in reference to FIG. 2) can apply quality-threshold techniques to create exemplary clusters of behavior data C1 and C2. As illustrated, the graph 300 includes different clusters C1 and C2 are illustrated indicated with the dashed circles.

The clustering module 206 can analyze the behavior database 204 as described above in reference to FIG. 2. The clustering module 206 can identify a first class of behavior data having a first label (e.g., those labeled as “positive”) and behavior data having a second label (e.g., those labeled as “negative”). The clustering module 206 can identify a specified distance (e.g., a minimum distance) between a first class behavior-data point (e.g., “positive” behavior-data point 302) and a second class behavior-data point (e.g., “negative” behavior-data point 304). The clustering module 206 can designate the specified distance as a quality threshold (QT).

The clustering module 206 can select the first behavior-data point 302 to add to the first cluster C1. The clustering module 206 can then identify a second behavior-data point 304 whose distance to the first behavior-data point 302 is less than the quality threshold and, in response to satisfying the threshold, add the second behavior-data point 304 to the first cluster C1. The clustering module 206 can iteratively add behavior-data points to the first cluster C1 until all behavior-data points whose distances to the first behavior-data point 302 are each less than the quality threshold have been added to the first cluster C1.

The clustering module 206 can remove the behavior-data points in C1 from further clustering operations and select another behavior-data point (e.g., behavior-data point 306) to add to a second cluster C2. The clustering module 206 can iteratively add behavior-data points to the second cluster C2 until all behavior-data points whose distances to the behavior-data point 306 are each less than the quality threshold have been added to the second cluster C2. The clustering module 206 can repeat the operations to create clusters C3, C4, and so on until all behavior-data points features are clustered.

The clustering module 206 can generate representative behavior data for each cluster. In some implementations, the clustering module 206 can designate the geometric center as the representative behavior data (e.g., mean of the behavior data in the cluster) of the cluster such as the center for cluster C1. The clustering module 206 may use other techniques for designating a behavior-data point as the representative behavior data. For example, the clustering module 206 may identify an example that is closest to other samples. In these instances, the clustering module 206 can calculate distances between pairs of behavior-data points in cluster C1 and determine a reference distance for each behavior-data point. The reference distance for a behavior-data point can be a maximum distance between the behavior-data point and another behavior-data point in the cluster. The clustering module 206 can identify a behavior-data point in cluster C1 that has the minimum reference distance and designate the behavior-data point as the representative data for cluster C1.

### Example Process for Managing Clustered Data

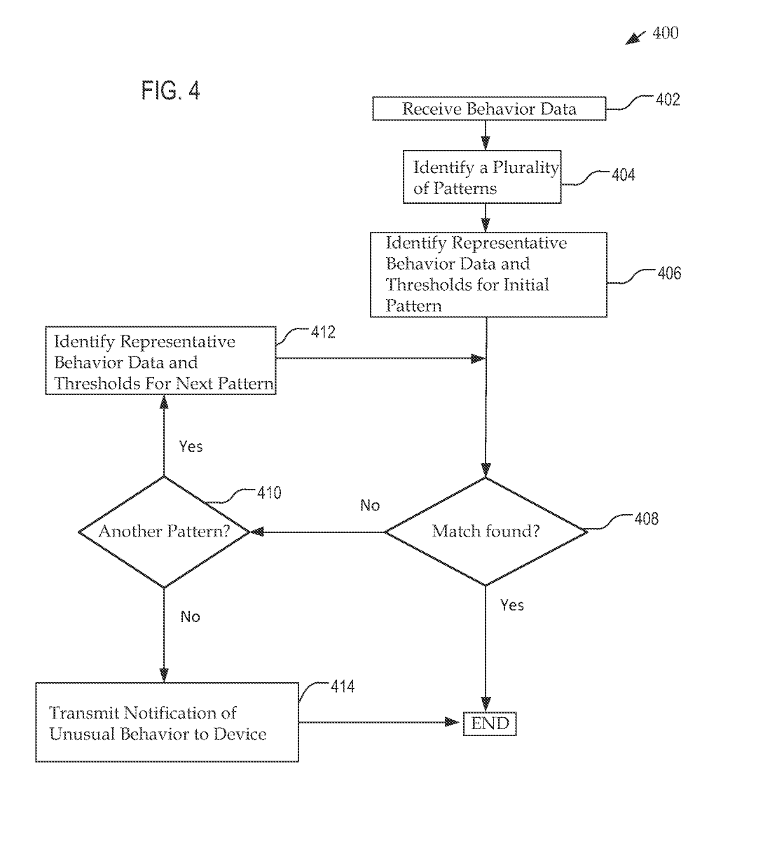

FIG. 4 is a flow chart illustrating example method for detecting unusual behavior in accordance with some implementations of the present disclosure. Method 400 is described with respect to the system 100 of FIG. 1. Though, the associated system may use or implement any suitable technique for performing these and other tasks. These methods are for illustration purposes only and the described or similar techniques may be performed at any appropriate time, including concurrently, individually, or in combination. In addition, many of the steps in these flowcharts may take place simultaneously and/or in different orders than as shown. Moreover, the associated system may use methods with additional steps, fewer steps, and/or different steps, so long as the methods remain appropriate.

Method 400 begins at step 402 where behavior data is received. For example, the behavior recognition server 104 of FIG. 1 may receive behavior data 110 including data from multiple behavior types. At step 404, a plurality of patterns is identified. As for the example illustrated in FIG. 1, the behavior recognition server 104 may retrieve or otherwise identify behavior patterns 112 based on previously-received behavior data. Next, at step 406, representative behavior data and associated thresholds for an initial pattern is identified. In the example, the behavior recognition server 104 may select an initial behavior pattern 112 and identify representative behavior data and associated thresholds. If the behavior data matches the representative behavior data and associated thresholds at decisional step 408, execution ends. Returning to the example, the behavior recognition server 104 may determine whether the behavior data 110 is within the range of values defined by the representative behavior data and associated thresholds, and, if so, no notifications are issued. If a match is not determined at decisional step 408, then execution proceeds to decisional step 410. If another pattern is available, then, at step 412, representative behavior data and thresholds are identified for the next pattern. Execution returns to decisional step 408. If another pattern is not available, then, at step 414, a notification of unusual behavior is transmitted to a device. Execution then ends. Again returning to the example, if the behavior recognition server 104 is unable to match the behavior data 110 to any of the behavior patterns 112, the behavior recognition server 104 transmits a notification to the mobile device 106a, 106b or the third-party device 107. For example, the notification 114 may lock the device 106a, 106b until a user is verified.

### Example Mobile Device Architecture

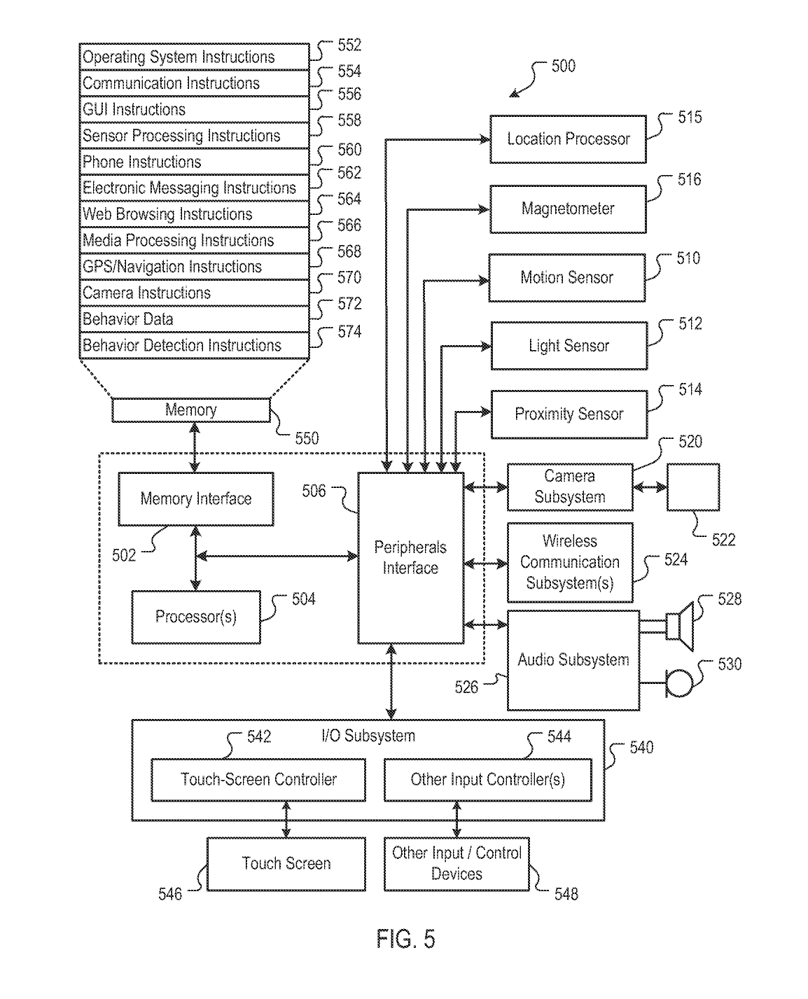

FIG. 5 is a block diagram of exemplary architecture 500 of a mobile device including an electronic magnetometer. The mobile device 500 can include memory interface 502, one or more data processors, image processors and/or central processing units 504, and peripherals interface 506. Memory interface 502, one or more processors 504 and/or peripherals interface 506 can be separate components or can be integrated in one or more integrated circuits. Various components in mobile device architecture 500 can be coupled together by one or more communication buses or signal lines.

Sensors, devices, and subsystems can be coupled to peripherals interface 506 to facilitate multiple functionalities. For example, motion sensor 510, light sensor 512, and proximity sensor 514 can be coupled to peripherals interface 506 to facilitate orientation, lighting, and proximity functions of the mobile device. Location processor 515 (e.g., GPS receiver) can be connected to peripherals interface 506 to provide geopositioning. Electronic magnetometer 516 (e.g., an integrated circuit chip) can also be connected to peripherals interface 506 to provide data that can be used to determine the direction of magnetic North.

Camera subsystem 520 and Optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 524, which can include radio frequency receivers and transmitters and/or optical (e.g., infrared) receivers and transmitters. The specific design and implementation of communication subsystem 524 can depend on the communication network(s) over which the mobile device is intended to operate. For example, the mobile device may include communication subsystems 524 designed to operate over a GSM network, a GPRS network, an EDGE network, a Wi-Fi or WiMax network, and a Bluetooth™ network. In particular, wireless communication subsystems 524 may include hosting protocols such that the mobile device may be configured as a base station for other wireless devices.

Audio subsystem 526 can be coupled to speaker 528 and microphone 530 to facilitate voice-enabled functions, such as voice recognition, voice replication, digital recording, and telephony functions. Note that speaker 528 could introduce magnetic interference to the magnetometer, as described in reference to FIGS. 1-2.

I/O subsystem 540 can include touch-screen controller 542 and/or other input controller(s) 544. Touch-screen controller 542 can be coupled to touch screen 546. Touch screen 546 and touch-screen controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 546.

Other input controller(s) 544 can be coupled to other input/control devices 548, such as one or more buttons, rocker switches, thumb-wheel, infrared port, USB port, docking station and/or a pointer device such as a stylus. The one or more buttons (not shown) can include an up/down button for volume control of speaker 528 and/or microphone 530.

In one implementation, a pressing of the button for a first duration may disengage a lock of touch screen 546; and a pressing of the button for a second duration that is longer than the first duration may turn power to the mobile device on or off. The user may be able to customize a functionality of one or more of the buttons. Touch screen 546 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod Touch®.

Memory interface 502 can be coupled to memory 550. Memory 550 can include high-speed random access memory and/or non-volatile memory, such as one or more magnetic disk storage devices, one or more optical storage devices, and/or flash memory (e.g., NAND, NOR). Memory 550 can store operating system instructions 552, such as Darwin, RTXC, LINUX, UNIX, OS X, WINDOWS, or an embedded operating system such as VxWorks. Operating system instructions 552 may include instructions for handling basic system services and for performing hardware dependent tasks. In some implementations, operating system instructions 552 can be a kernel (e.g., UNIX kernel).

Memory 550 may also store communication instructions 554 to facilitate communicating with one or more additional devices, one or more computers and/or one or more servers. Memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes and instructions; camera instructions 570 to facilitate camera-related processes and functions; behavior data 572 and behavior detection instructions 574 to facilitate detecting unusual behavior, as described in reference to FIG. 1-4. In some implementations, GUI instructions 556 and/or media processing instructions 566 implement the features and operations described in reference to FIGS. 1-4.

Memory 550 may also store other software instructions (not shown), such as web video instructions to facilitate web video-related processes and functions; and/or web shopping instructions to facilitate web shopping-related processes and functions. In some implementations, media processing instructions 566 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 550.

Each of the above-identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application-specific integrated circuits.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more them. The term “data processing apparatus” means all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A method for determining behavior associated with a user device, comprising:
receiving behavior data identifying multiple types of user interaction with the user device;
comparing the behavior data with patterns of behavior data associated with the user device, wherein the behavior-data patterns are generated from previously-received behavior data of an original user;
determining a current user is potentially different from the original user based on the comparison of the behavior data with the patterns; and
transmitting a command to the user device to lock the user device until the current user is verified as the original user.

2. The method of claim 1, wherein the multiple types of user interaction includes at least one of grammar, punctuation, typing speed, spelling errors, vocabulary, application usage, online activity, or communication with third-party devices.

3. The method of claim 1, wherein comparing the behavior data with patterns of behavior data comprises:
iteratively identifying representative behavior data and an associated threshold for each type of user interaction with the user device for the patterns; and
for each iteration, determining whether the behavior data matches a magnitude range for a pattern selected during that iteration, wherein the magnitude range for each type of behavior data is defined by the representative behavior data and the associated threshold.

4. The method of claim 1, wherein the behavior data includes data from multiple sensors.

5. The method of claim 4, wherein the data from multiple sensors includes data from at least one of a magnetometer, a location processor, a light sensor, an accelerometer, thermometer, a proximity sensor, or a touch screen.

6. The method of claim 1, further comprising applying a pattern recognition technique to previously received behavior data to generate patterns of behavior data.

7. The method of claim 1, further comprising presenting a request to select participation in determining unusual behavior patterns or filtering out certain types of behavior data.

8. A method for determining behavior associated with a user device, comprising:
receiving data from multiple sensors identifying current physical activity and an associated time from the user device;
comparing the data from multiple sensors and the associated time with patterns of sensor data associated with the user device, wherein the sensor-data patterns are generated from previously-received data from multiple sensors and associated times associated with a user;
determining the current physical activity indicates unusual physical activity for the user based on the comparison of the data with the patterns; and
transmitting a notification to a third-party device indicating the unusual physical activity of the user.

9. The method of claim 8, further comprising:
receiving relative locations associated with the data from multiple sensors and the associated time period; and
determining whether the data from the multiple sensors, the associated time period, and the relative locations match any of the patterns of sensor data.

10. The method of claim 8, wherein the data from multiple sensors includes data from at least two of a magnetometer, a location processor, a light sensor, an accelerometer, thermometer, a proximity sensor, or a touch screen.

11. The method of claim 8, wherein the unusual physical activity indicates a period of inactivity at a residence of the user.

12. A computer program product encoded on a non-transitory medium, the product comprising computer readable instructions for causing one or more processors to perform operations comprising:
receiving behavior data identifying multiple types of user interaction with the user device;
comparing the behavior data with patterns of behavior data associated with the user device, wherein the behavior-data patterns are generated from previously-received behavior data of an original user;
determining a current user is potentially different from the original user based on the comparison of the behavior data with the patterns; and
transmitting a command to the user device to lock the user device until the current user is verified as the original user.

12. The computer program product of claim 11, wherein the multiple types of user interaction includes at least one of grammar, punctuation, typing speed, spelling errors, vocabulary, application usage, online activity, or communication with third-party devices.

13. The computer program product of claim 11, wherein the instructions comprising comparing the behavior data with patterns of behavior data includes the instructions comprising:
iteratively identifying representative behavior data and an associated threshold for each type of user interaction with the user device for the patterns; and
for each iteration, determining whether the behavior data matches a magnitude range for a pattern selected during that iteration, wherein the magnitude range for each type of behavior data is defined by the representative behavior data and the associated threshold.

14. The computer program product of claim 11, wherein the behavior data includes data from multiple sensors of the user device.

15. The computer program product of claim 14, wherein the data from multiple sensors includes data from at least two of a magnetometer, a location processor, a light sensor, an accelerometer, thermometer, a proximity sensor, or a touch screen.

16. The computer program product of claim 11, the instructions further comprising applying a pattern recognition technique to previously received behavior data to generate patterns of behavior data.

17. The computer program product of claim 11, the instructions further comprising presenting a request to select participation in determining unusual behavior patterns or filtering out certain types of behavior data.

18. A computer program product encoded on a non-transitory medium, the product comprising computer readable instructions for causing one or more processors to perform operations comprising:
receiving data from multiple sensors identifying current physical activity and an associated time from the user device;
comparing the data from multiple sensors and the associated time with patterns of sensor data associated with the user device, wherein the sensor-data patterns are generated from previously-received data from multiple sensors and associated times associated with a user;
determining the current physical activity indicates unusual physical activity for the user based on the comparison of the data with the patterns; and
transmitting a notification to a third-party device indicating the unusual physical activity of the user.

19. The computer program product of claim 18, the instructions further comprising:
receiving relative locations associated with the data from multiple sensors and the associated time period; and
determining whether the data from the multiple sensors, the associated time period, and the relative locations match any of the patterns of sensor data.

20. The computer program product of claim 18, wherein the data from multiple sensors includes data from at least two of a magnetometer, a location processor, a light sensor, an accelerometer, thermometer, a proximity sensor, or a touch screen.
